(19) United States
(12) Patent Application Publication
(10) Pub. No.: US 2005/0096086 A1
(43) Pub. Date: May 5, 2005

(54) Computer interface with both wired and wireless links

(75) Inventor: Suresh Singamsetty, San Diego, CA (US)

Correspondence Address: GEORGE O SAILE, 28 DAVIS AVENUE, POUGHKEEPSIE, NY, 12603, US

(73) Assignee: Jaalaa, Inc.

(21) Appl. No.: 10/978,626

(22) Filed: Nov. 1, 2004

Related U.S. Application Data
(60) Provisional application No. 60/516,181, filed on Oct. 31, 2003.

(51) Int. Cl. H04Q 7/20

(52) U.S. Cl. 455/557

(57) ABSTRACT

Computer and peripheral interfaces that have both wired communication and wireless communication interfaces are provided. In one implementation, one of the two communication interfaces may be activated while the other interface is inactive and is used as a backup. When the operating interface fails, control logic detects the failure and activates the backup interface to maintain the communication. In other implementations, the user can select which of the two types of communication interface is desired.

This application claims priority to U.S. Provisional Patent Application Ser. No. 60/516,181, filed on Oct. 31, 2003, which is herein incorporated by reference.

### BACKGROUND OF THE INVENTION

1. Field of the Invention

The present invention generally relates to a computer interface between a computer and an input device for the computer. More particularly, this invention relates to a system, a method and devices which support both wired and wireless interfaces.

2. Description of the Prior Art

Various computers and microprocessor-based devices and systems provide one or more user input devices to allow a user to control certain operations. Such an input device may be separated from the host computer or device and thus a communication link and an interface may be implemented to support proper communications between the input device and the host computer or device. Generally, each of the input device and host computer/device includes appropriate software and hardware for the communication link and interface.

For example, a typical desktop or laptop computer may have a keyboard and a pointing device for a user to input data or commands for controlling or operating the computer. Examples of the pointing device for computers include a mouse, a touch pad, a trackball, and a pointing stick (IBM laptops). In addition to keyboards and pointing devices, examples of some other user input devices include joysticks and game pads for computers and microprocessor-based game machines, control units for other microprocessor-based devices. In general, a user uses an input button, a control stick, one key or a key combination, or a combination thereof to input data or a command. Circuitry in the input device converts the input data or command into a proper form for transmitting to the computer or device.

Such an input device generally uses a particular communication link to transmit the input data or command to the computer or device. An input device may be a wireless input device using a wireless communication link or a wired link using an electrical cable. Input devices with wired links may be implemented based on the PS/2 keyboard interface, USB 1.0 and USB 2.0 and other interfaces. The wireless communication link may be implemented by a radiation transmitter to send the input to a corresponding radiation receiver at the computer or device. Many wireless input devices use RF radiation links based on different radio interfaces such as IEEE 802.5.14 for low speed links and wireless USB 2.0 and IEEE 1394 for relatively high speed links. Some of these wired or wireless input devices may use the Human Interface Device (HID) protocol over wired or wireless USB links or other non-USB communication links.

U.S. Pat. No. 6,169,789 (Rao, et al.) describes an intelligent keyboard, which can operate as a universal compute, command, and control module which interfaces either through wired or wireless means with a several intelligent appliances, personal computers, work-stations, servers, printers, televisions, or other devices. The intelligent keyboard may work in conjunction with a local or network server to perform standard computing functions, serve as a command and control unit, perform standard telephony functions, send and receive email, voicemail, video and audio.

U.S. Pat. No. 6,747,634 B1 (Yang) discloses an integrated mouse or trackball system which includes either a wired interface for the mouse or trackball device, or a wireless receiver coupled to a wired or wireless relay keyboard. Positioning structures are included for optionally enabling the mouse or trackball device to be coupled to the interface device or receiver from either the right-hand or left-hand side of the keyboard, or from both sides of the keyboard.

U.S. Patent Application Publication US2004/0198430 A1 (Moriyama, et al.) describes a system of communication between a display device and a processing apparatus (host). There are two connection modes. First, there is a wired connection mode for communication along a wired connection path. Second, there is a wireless connection mode for communication along a wireless connection path. Before entering the wireless connection mode, the processing apparatus (host) transmits, along the wired connection path to the display device, data required for the wireless connection of the display device, along the wireless connection path.

### SUMMARY OF THE INVENTION

It is therefore an object of the present invention to provide a system, a method and devices which support both wired and wireless interfaces.

The objects of this invention are achieved by a computing device comprised of a wired interface for attaching peripherals, and a wireless interface for attaching these peripherals. These peripherals comprise input devices such as keyboards, mice, trackballs, joysticks, control pads, game pads, pointing sticks, and tablets. These computing devices comprise personal computers, servers, large computers, medium computers, microprocessor-based devices, and microprocessor-based game machines.

The computing device further includes a control circuit to control wireless and wired communications between the computing device and the peripherals. The control circuit may activate only either one of the wireless interface or the wired interface, for a given peripheral, wherein an inactive interface acts as a backup to an active interface. The control circuit may control the computing device and the peripherals to first communicate with default interface, wherein the default interface comprises the wireless interface and the wired interface, wherein the default interface is specified by a user, wherein a non-default interface is a backup interface to the default interface and the backup interface is activated only when the default interface fails, cannot be established, or is deselected by a user.

The control circuit allows simultaneous interfacing between the computing device and some of the peripherals via the wired interface and between the computing device and some of the peripherals via the wireless interface, wherein the simultaneous interfacing allows for sharing of the computing device between wired and wireless products. The control circuit allows simultaneous interfacing between the computing device and two or more of the peripherals via the wired interface, providing for multiple wired interfaces on the computing device. The control circuit allows simultaneous interfacing between the computing device and two or more of the peripherals via the wireless interface, providing for multiple wireless interfaces on the computing device.

The above and other objects, features and advantages of the present invention will be better understood from the following detailed description taken in conjunction with the accompanying drawings.

### BRIEF DESCRIPTION OF THE DRAWINGS

FIG. 1 is a block diagram of a system using the interfaces of the main embodiment of this invention.

FIG. 2 is a flowchart representing parts of the main embodiment of this invention.

### DESCRIPTION OF THE PREFERRED EMBODIMENT

A computer interface that has both wired communication interface and wireless communication interface is described herein. In one embodiment of the invention, one of the two communication interfaces for an input device may be activated while the other interface is inactive and is used as a backup. When the operating interface fails, a control logic detects the failure and activates the backup interface to maintain the normal communication between the input device and the host computer.

In comparison, many conventional wireless appliances, such as the keyboard mentioned having a wireless component which serves to replace the cable found in a traditionally wired product, do not include means to support previously available wired connections. The invention allows a device to have both a “cable replacement” component, i.e., the wireless connection, and a cable connection.

This availability of wired and wireless interfaces in a system provides a number of advantages. For example, this system may be used to upgrade a wired system to a wireless system and to add mobility to a device by using the wireless connection. The user may continue operation of the host computer or device with the wired interface when the wireless interface fails due to failure of the battery power in the input device, failure or malfunction of the wireless link caused by severe RF interference or other failures in the wireless interface. The dual interface also allows for sharing a host computer or appliance between wired and wireless products. For manufacturers of electronic devices and systems, implementation of this dual mode interface allows for immediate commercial distribution of a dual mode appliance (such as a keyboard) and potential for incremental sales later when users upgrade to wireless systems.

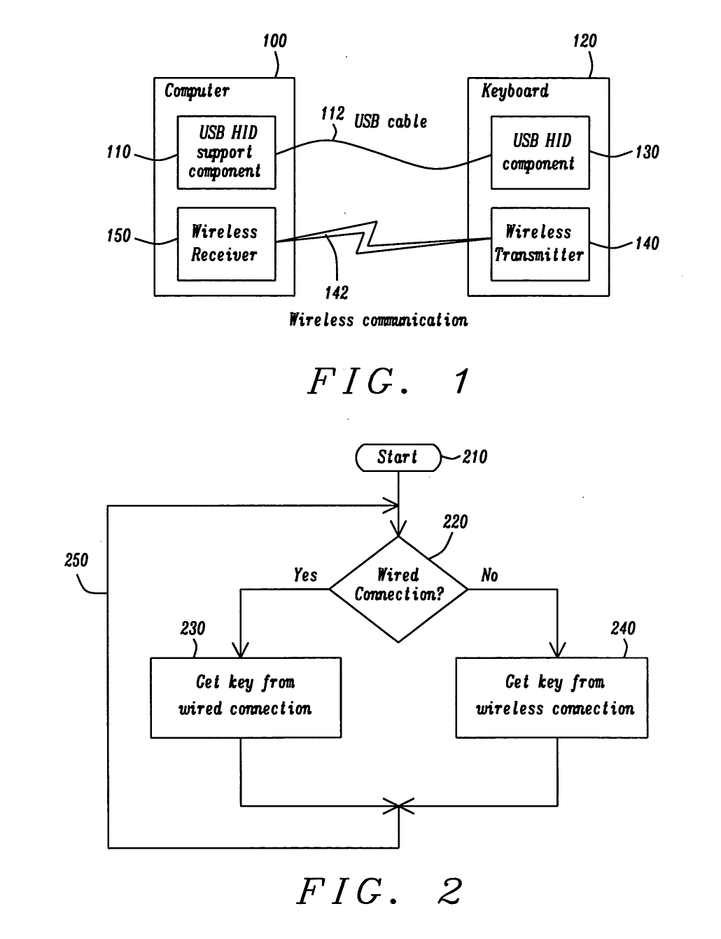

FIG. 1 shows one embodiment of this dual interface in a computer 100 and its input device 120. A keyboard as the input device 120 is described here as a specific example. The computer keyboard 120 is in one chassis and the computer 100 is typically housed in a separate chassis.

The keyboard 120 is equipped with hardware and software 130 sufficient to configure it as a wired USB HID keyboard device. Similarly, the computer 100 is equipped with hardware and software 110 supporting connection to the wired USB HID keyboard device 120. A cable 112 is connected between the components 110 and 130 as the wired link. A user operates the keyboard 120 to send data and commands through the cable 112 to the computer part 110.

In addition to the above wired interface, this keyboard 120 is equipped with a wireless transmitter 140 to send keystroke information to a compatible wireless receiver 120 in the computer 100. The receiver 150 may be built into the computer chassis or added as an external peripheral device of the computer. As an external peripheral device, the receiver 150 may be either be interfaced to the computer 100 through a wired USB connection or by other available means such as the PS/2 keyboard connector. This wireless interface allows the computer 100 and the keyboard 120 to communicate through a wireless RF link 142 in which the transmitter 140 sends an RF signal to the receiver 150 through the air.

A control mechanism may be implemented to control and select the two interfaces. In most applications, only one interface may be in operation while the other interface is set to be inoperative. In certain applications, it may be desirable to simultaneously use both interfaces.

In one implementation of the control mechanism for operating one interface at a time, a user may manually select one of the two interfaces via a software control application or a control switch. When the wired connection 112 is available, for example, the wireless interface may be automatically disabled.

The control mechanism may also be implemented as an automatic control where a default interface is used unless the default interface fails. A sensing mechanism is used to monitor the operation of the default interface. When the failure of the default interface is detected, the control activates the backup interface to maintain the communication between the keyboard 120 and the computer 100.

FIG. 2 illustrates the control logic for the system in FIG. 1 when the default interface is the wireless interface. At step 210, the control is initiated to control the operation of the two interfaces. At step 220, the control logic checks whether the wireless interface is in operation. This may be achieved by using the wireless receiver 150 and its processing circuit to determine whether the wireless connection is established. If the wireless connection 142 between the host computer 100 and the keyboard 120 is present, the control logic directs the host computer 100 to get key or other information from the wireless connection 142 (step 240). Otherwise, the control logic directs the host computer 100 to get key or other information from the wired connection 112. The control logic uses the loop 250 to continue to monitor the default wireless connection 142.

Wireless communications between a host computer and an input device such as keyboard and computer may be implemented by various techniques, some of which are well known in the art. Examples include devices conforming to Bluetooth HID profile and products manufactured specifically for wireless keyboard applications.

In other embodiments, input devices may be equipped with multiple hardware interfaces for connection to computer or other appliances (e.g. USB and PS/2 keyboard interface). Similarly, input devices may be equipped with multiple mechanisms for establishing wireless links (e.g. Bluetooth, Zigbee, and other suitable interfaces).

The advantages of this invention are multi-fold. It provides communications backup for wired and wireless connected devices. If an input device, such as a keyboard is normally connected via a wireless link, which becomes faulty, the control logic can automatically switch to the wired connection interface. In another embodiment, a computer device or an input device can have multiple wired interfaces and multiple wireless interfaces.

While the invention has been described in terms of the preferred embodiments, those skilled in the art will recognize that various changes in form and details may be made without departing from the spirit and scope of the invention.

1. A system, comprising:
a host computer; and
an input device operable to communicate with said host computer to send data and commands to said host computer, said input device comprising a wireless interface to wirelessly communicate with said host computer and a wired interface to communicate with said host computer via a wired link,
wherein said host computer comprises a wireless interface to receive a wireless signal from said input device and a wired interface to receive a signal from the wired link.

2. The system as in claim 1, further comprising a controller to control wireless and wired communications between said host computer and said input device, wherein said controller maintains only either one of wireless and wired communications.

3. The system as in claim 2, wherein said controller controls said host computer and said input device to first communicate wirelessly and evokes communications via the wired link only when a wireless communication fails or cannot be established.

4. The system as in claim 1, wherein said input device comprises a computer keyboard.

5. The system as in claim 1, wherein said input device comprises a computer pointing device.

6. The system as in claim 5, wherein said computer pointing device comprises a computer mouse.

7. The system as in claim 5, wherein said computer pointing device comprises a trackball.

8. The system as in claim 5, wherein said computer pointing device comprises a computer touchpad.

9. The system as in claim 1, wherein said input device comprise a joystick.

10. The system as in claim 1, wherein said input device comprise a control pad.

11. The system as in claim 1, wherein said wired interface is based on a Universal Serial Bus, USB, protocol.

12. The system as in claim 1, wherein said wireless interface is based on IEEE 802.5.14.

13. The system as in claim 1, further comprising a second input device having a wired communication interface to communicate with said host computer via a cable and a wireless communication interface to wirelessly communicate with said host computer.

14. A method, comprising the steps:
providing both wired communication interface and wireless communication interface between a host computer and a computer input device,
controlling the host computer and the computer input device to communicate via a first interface of the wired communication interface and wireless communication interface while setting a second interface inoperative,
activating the second interface to maintain communication between the host computer and the compute input device, when the first interface becomes inoperative.

15. A computing device comprising:
a wired interface for attaching one or more peripheral devices, and
a wireless interface for attaching one or more of said peripheral devices.

16. The computing device of claim 15, wherein said peripheral devices are keyboards, mice, trackballs, joysticks, control pads, game pads, pointing sticks, or tablets.

17. The computing device of claim 15, wherein said computing device is a personal computer, server, large computer, medium computer, microprocessor-based device, or microprocessor-based game machine.

18. The computing device of claim 15 further comprising a control circuit to control wireless and wired communications between said computing device and said peripheral device, wherein said control circuit activates only either one of said wireless interface or said wired interface, for a given said peripheral, creating an active interface and an inactive interface, and wherein said control circuit uses said inactive interface as a backup to said active interface.

19. The computing device of claim 18 wherein said control circuit establishes a default interface, wherein said default interface comprises said wireless interface or said wired interface, and wherein said default interface is specified by a user,

20. The computing device of claim 19 wherein a non-default interface is a backup interface to said default interface, and said backup interface is activated only when said default interface fails, cannot be established, or is deselected by a user.

21. The computing device of claim 16, wherein said control circuit allows simultaneous interfacing between said computing device and one of more of said peripheral devices via said wired interface, and between said computing device and one or more of said peripheral devices via said wireless interface, wherein said simultaneous interfacing allows for sharing of said computing device between wired and wireless products.

22. The computing device of claim 18, wherein said control circuit allows simultaneous interfacing between said computing device and two or more of said peripheral devices via said wired interface, providing for multiple wired interfaces on said computing device.

23. The computing device of claim 18, wherein said control circuit allows simultaneous interfacing between said computing device and two or more of said peripheral devices via said wireless interface, providing for multiple wireless interfaces on said computing device.

24. The computing device of claim 15 wherein said wired interface is a PS/2 keyboard interface, USB 1.0 interface, or USB 2.0 interface.

25. The computing device of claim 15 wherein said wireless interface comprises a radiation transmitter and a radiation receiver.

26. The computing device of claim 25 wherein said radiation transmitter is located in said peripheral device, and said radiation receiver is located in said computing device.

27. The computing device of claim 15 wherein said wireless interface is a IEEE 802.5.14 interface, wireless USB 2.0 interface, or IEEE 1394 interface.

28. An input device comprising:
a wired interface for attaching to a computing device, and
a wireless interface for attaching to said computing device.

29. The input device of claim 28 wherein said computing device is a computer, server, and interconnect switch.

30. The input device of claim 28 further comprising a control circuit to control wireless and wired communications between said computing device and said input device, wherein said control circuit activates only either one of said wireless interface or said wired interface, for a given said input device, creating an active interface and an inactive interface, and wherein said control circuit uses said inactive interface as a backup to said active interface.

31. The input device of claim 30 wherein said control circuit establishes a default interface, wherein said default interface comprises said wireless interface or said wired interface, and wherein said default interface is specified by a user.

32. The input device of claim 31 wherein a non-default interface is a backup interface to said default interface, and said backup interface is activated only when said default interface fails, cannot be established, or is deselected by a user.

33. The input device of claim 28, wherein said control circuit allows simultaneous interfacing between said computing device and one of more of said input devices via said wired interface, and between said computing device and one or more of said input devices via said wireless interface, wherein said simultaneous interfacing allows for sharing of said computing device between wired and wireless products.

34. The input device of claim 33, wherein said control circuit allows simultaneous interfacing between said computing device and two or more of said input devices via said wired interface, providing for multiple wired interfaces on said computing device.

35. The input device of claim 33, wherein said control circuit allows simultaneous interfacing between said computing device and two or more of said input devices via said wireless interface, providing for multiple wireless interfaces on said input device.

36. The input device of claim 28 wherein said wired interface is a PS/2 keyboard interface, USB 1.0 interface, or USB 2.0 interface.

37. The input device of claim 28 wherein said wireless interface comprises a radiation transmitter and a radiation receiver.

38. The input device of claim 37 wherein said radiation transmitter is located in said input device, and said radiation receiver is located in said computing device.

39. The input device of claim 28 wherein said wireless interface is a IEEE 802.5.14 interface, wireless USB 2.0 interface, or IEEE 1394 interface.

40. A method, comprising the steps of:
providing both a wired communication interface and a wireless communication interface between a host computer and a computer input device;
controlling the host computer and the computer input device to communicate via a first interface of the wired communication interface and wireless communication interface while setting a second interface inoperative; and
activating the second interface to maintain communication between the host computer and the compute input device, when the first interface cannot be established.

41. A method, comprising the steps of:
providing both a wired communication interface and a wireless communication interface between a host computer and a computer input device;
controlling the host computer and the computer input device to communicate via a first interface of the wired communication interface and wireless communication interface while setting a second interface inoperative; and
activating the second interface to maintain communication between the host computer and the compute input device, when the first interface is deselected by a user.
